(19) United States
(12) Patent Application Publication
(10) Pub. No.: US 2004/0073351 A1
(43) Pub. Date: Apr. 15, 2004

(54) Method for regulating directional stability

(76) Inventor: Markus Haberhauer, Griesheim (DE)

Correspondence Address: Gerlinde M Nattler, Continental Teves Inc, One Continental Drive, Auburn Hills, MI, 48326, US

(21) Appl. No.: 10/467,390

(22) PCT Filed: Jan. 25, 2002
(86) PCT No.: PCT/EP02/00756

(30) Foreign Application Priority Data
Jan. 26, 2001 (DE) 101 03 705.8

(51) Int. Cl. G06F 19/00

(52) U.S. Cl. 701/70; 701/1

(57) ABSTRACT

In a method of controlling the driving stability of a vehicle, signal errors emitted by yaw rate sensors are detected/determined by way of monitoring strategies. In order to increase the reliability of driving stability control operations, it is determined during stationary driving behavior with a steering movement whether the value of the yaw rate signal \dot{ψ}_{Sensor} deviates in percentage or nominally from a redundant value \dot{ψ}ₘₑₐₙ produced from other measured or calculated variables related to the vehicle. In this case, the control of driving stability is influenced under the condition that a comparison value calculated from the value of the yaw rate signal and the redundant value exceeds a predetermined threshold value.

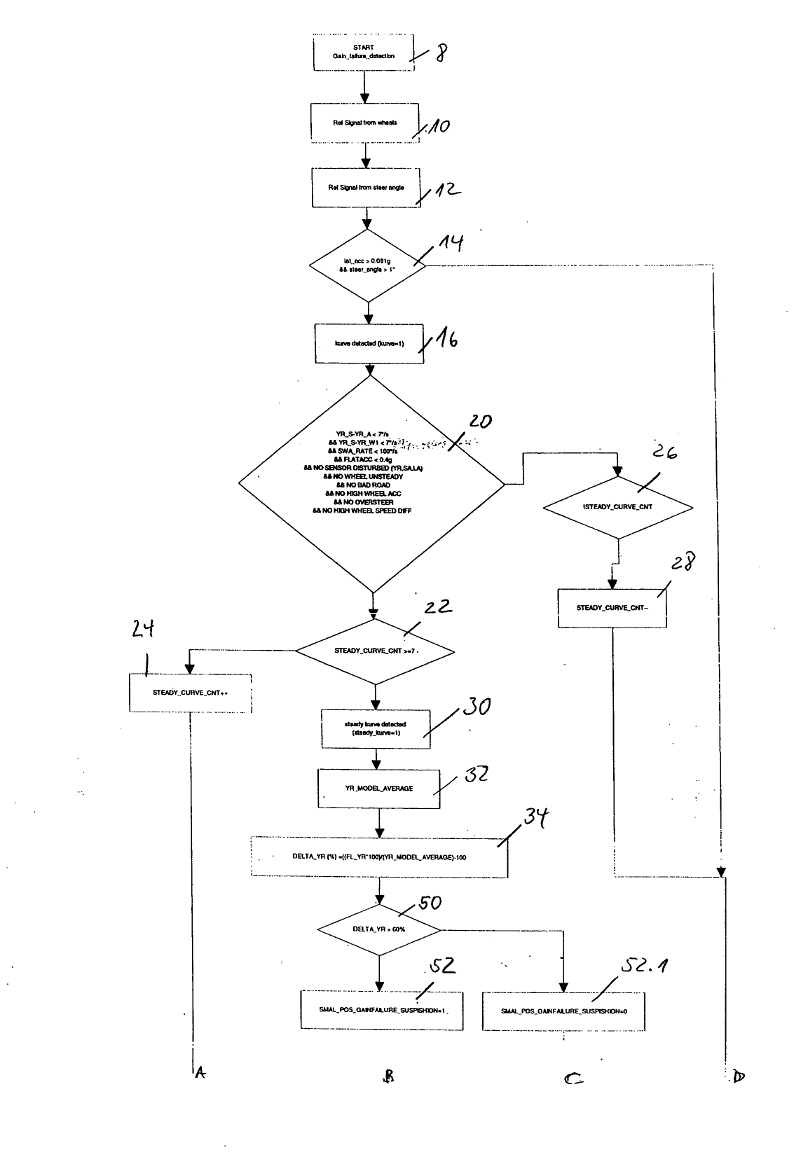

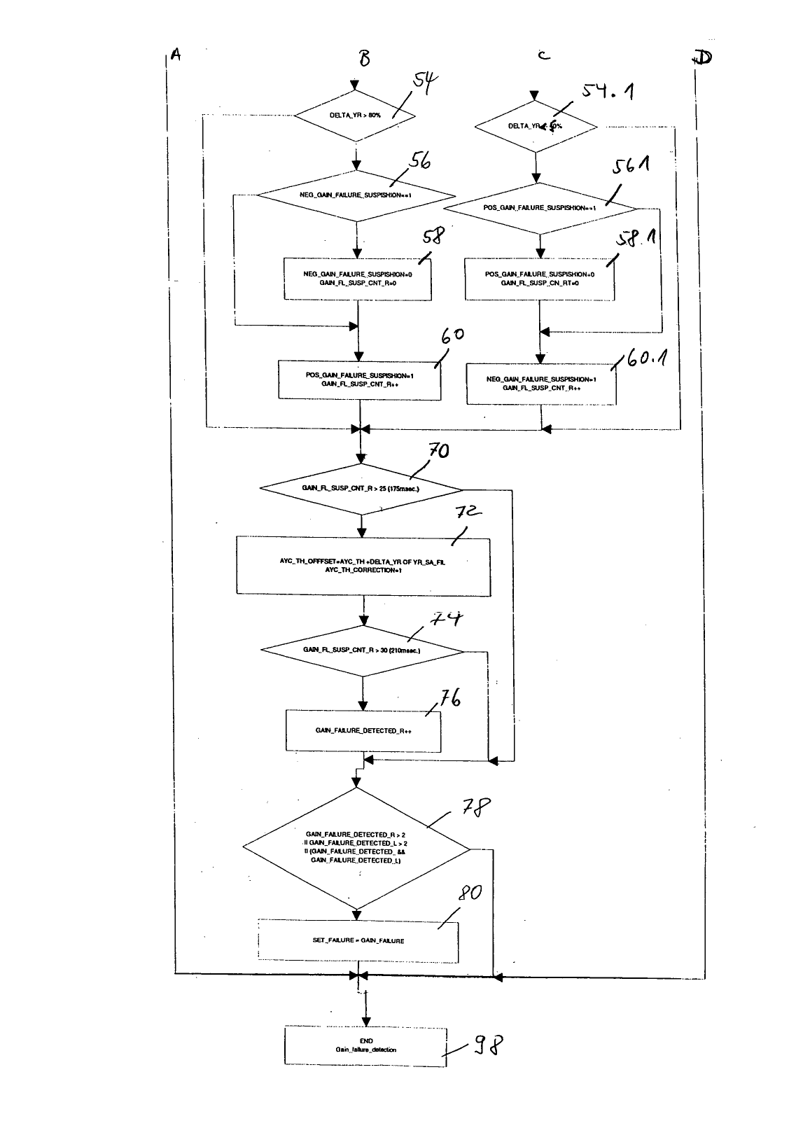

### BACKGROUND OF THE INVENTION

The present invention relates to a method of controlling the driving stability of a vehicle, in particular in an electronic stability program (ESP), wherein signal errors (yaw rate scaling errors) emitted by yaw sensors are determined by way of monitoring strategies.

Electronic stability programs of this type are driving-dynamics control systems for vehicles used to support the driver in critical driving situations while braking, accelerating, and steering, and to intervene where the driver does not have any possibility of direct intervention. The control system assists the driver in braking operations, especially on a roadway with a low or varying coefficient of friction, on which the vehicle could no longer be controllable or could get into a sliding condition due to locking wheels. It further assists in accelerating maneuvers, when there is the risk of the drive wheels spinning, and finally in steering maneuvers in a curve when the vehicle could oversteer or understeer. In total, not only comfort but also active safety is essentially improved.

A control system of this type is based on a closed control circuit assuming typical control tasks in normal operations of the vehicle and being required to catch the vehicle as quickly as possible in extreme driving situations. Sensors for sensing various driving-dynamics parameters are of particular importance as generators of actual values. A plausible control supposes that the sensors correctly represent the actual condition of the controlled system. This is especially significant in driving stability control operations in extreme driving situations when a deviation needs being adjusted by the control in a very short time already. For this reason, constant monitoring of the ESP sensors (yaw rate sensor, lateral acceleration sensor, steering angle sensor) in an electronic stability program is required. The purpose of corresponding online monitoring of the sensor is early detection of defects in the ESP sensors in order to prevent control errors that might cause a safety-critical vehicle condition.

Due to production, scaling errors of the sensor signal may occur in the yaw rate sensors used. These errors may appear in the range of ±6% . . . ±20 and −50%. . . −90 as well as +50% . . . +330%. Scaling errors in the amount of more than 100% are considered critical because they may have a major impact on the vehicle's performance due to a control error.

In view of the above an object of the present invention is to provide a method and a device for monitoring sensors of the type initially referred to exhibiting an extent of reliability that is especially necessary for an electronic stability program (ESP) for vehicles.

### SUMMARY OF THE INVENTION

According to the invention this object is achieved in that a generic method is so implemented that during stationary driving behavior with a steering movement it is determined whether the value of the yaw rate signal \dot{ψ}_{Sensor} deviates in percentage or nominally from a redundant value \dot{ψ}ₘₑₐₙ produced from other measured or calculated variables of the vehicle, and that in this. case the control of driving stability is influenced under the condition that a comparison value produced from the value of the yaw rate signal and the redundant value exceeds a predetermined threshold value.

It is appropriate that the value of the yaw rate signal is compared with the redundant value when a counter reaches a predetermined value.

To further improve the said method it is advantageous that the counter is increased in dependence on a time lapsed during which the stationary driving behavior with a steering movement is determined.

It is particularly suitable that stationary driving behavior is determined when at least one of the following conditions is satisfied:

a) |\dot{ψ}ₘ_{_{L}}−\dot{ψ}_{mq}|<a first threshold value K1, preferably 12°/s, especially 7°/s

b) |\dot{ψ}ₘ_{_{L}}p31 \dot{ψ}ₘ_{_{ν}}|<a second threshold value K2, preferably 12°/s, especially 7°/s

c) δLP|<a third threshold value K3, preferably 200°/s, especially 100°/s

d) |α_{q}|<a fourth threshold value K4, preferably 0.7 g, especially 0.5 g

e) anti-lock control (ABS), electronic brake force distribution (EBD), brake intervention-traction slip control is not active, and/or

f) the wheels of the vehicle do not show non-stationary wheel behavior (slip criteria)

g) the vehicle does not show oversteering driving behavior

h) the vehicle does not show understeering driving behavior.

Further, it is favorable that a steering movement is determined when at least the conditions are satisfied that the amount of the steering angle at the wheel exceeds a threshold value L1, preferably is >1°, and the amount of the lateral acceleration exceeds a threshold value Q1, preferably is >0.081 g.

It is expedient that the redundant value is produced from at least two model-based variables in which at least one of the following variables is included: wheel speeds of the wheels, track width, steering wheel angle, wheel base, vehicle speed, vehicle reference speed, the characteristic vehicle speed, or the steering velocity.

For further improving the control behavior it is favorable that the redundant value is produced by way of averaging according to the relation

$${\dot{ψ}}_{mean} = \frac{( {\dot{ψ}}_{{m}_{v}} + {\dot{ψ}}_{{m}_{L}} )}{2} ,$$

wherein \dot{ψ}ₘ_{_{ν}}is calculated according to the relation

$${\dot{ψ}}_{{m}_{v}} = \frac{{v}_{vr} - {v}_{vl}}{S}$$

and

\dot{ψ}ₘ_{_{L}} is calculated according to the relation

$${\dot{ψ}}_{{m}_{L}} = \frac{{δ}_{L}}{{i}_{L} l} \frac{{v}_{ref}}{( 1 + {( \frac{{v}_{ref}}{{v}_{ch}} )}^{2} )} .$$

\dot{ψ}_{mq} or \dot{ψ}ₘₕ may be used as further models for determining the redundant value \dot{ψ}ₘₑₐₙ.

It is especially favorable that a percentage difference value is determined as a comparison value from the deviation of the value of the yaw rate signal from the redundant value.

Advantageously, two separate counters are started when the scaling error is detected to record the case of error prevailing.

a) A first counter is increased when GF_{right}>Max_scaling error threshold (80%) in a stationary right-hand curve.

b) A second counter is increased when GF_{left}>Max_scaling error threshold (80%) in a stationary left-hand curve.

The two counters employed are also used when a negative scaling error (<−50%) is detected. When a positive scaling error was detected before, first the counters are reset before they are used again. The reason is that it is impossible for a positive and a negative scaling error to occur at the same time. A yaw rate sensor offset may be expected when such a behavior occurs.

It is, therefore, expedient that a flag (bit) (SMAL_POS_GAIN_FAILURE_SUSPICION) is set for defining a scaling error suspicion when the percentage difference value exceeds a threshold value K5 (DELTA_YA>60%). Also, it is facorable that a flag (bit) (POS_GAIN_FAILURE_SUSPICION or NEG_GAIN_FAILURE_SUSPICION) is set when the percentage difference value exceeds a positive threshold value K6 (DELTA_YR>80%) or negative threshold value K7 (DELTA_YR<−50%).

The value of a counter for a positive scaling error suspicion or the value of a counter for a negative scaling error suspicion is increased when a positive (>80%) or negative scaling error (<−50%) was determined.

It is likewise favorable that an ESP entry and/or exit threshold is increased by a model-based redundant value \dot{ψ}ₘ_{_{L}} that is weighted with a factor of the percentage difference value Δ\dot{ψ}(%) when the value of the counter exceeds a threshold value K8.

It is still further favorable that the model-based redundant value is calculated according to the following relation

$${\dot{ψ}}_{{m}_{L}} = \frac{{δ}_{L}}{{i}_{L} l} \frac{{v}_{ref}}{( 1 + {( \frac{{v}_{ref}}{{v}_{ch}} )}^{2} )} .$$

The entry threshold is weighted with a correction value.

The system is deactivated when both counters (POS_GAIN_FAILURE_SUSPICION or NEG_GAIN_FAILURE_SUSPICION) have detected this error for a fixed time (e.g. 3 sec maximally). It is therefore expedient that driving stability control is terminated when a counter has reached or exceeded a ninth threshold value K9 and the number of exceeding actions satisfies a predefined provision. In accordance with determined driving situations it is further advantageous to carry out system intervention when detected errors in a direction (left-hand-curve or right-hand curve) have been confirmed two times again, meaning that detected errors in a direction that have been confirmed two times are acknowledged as errors. For example, yaw rate control (ESP=AYC function) or AYC and traction slip control (TCS function) may be deactivated. This becomes apparent in urban traffic frequently showing more right-hand curves than left-hand curves.

It is favorable that an error is registered in an error memory when the control of driving stability is terminated.

For further improvement of the said method it is appropriate that all counters are reset when an ESP oversteering condition is found out.

It is particularly appropriate that all counters are reset when no further scaling threshold exceeding actions are detected in a predetermined period.

The method of the invention favorably permits

a) detecting a scaling error within a short time with a magnitude of error >80% or <−50%.

b) influencing the ESP control strategy when a scaling error occurs, with the intention of avoiding wrong reactions of the controller.

c) avoiding unjustified erroneous detections.

### BRIEF DESCRIPTION OF THE DRAWING

The attached drawings constitute a flow chart depicting a monitoring method according to the invention. The flow chart is spread over two pages due to space reasons.

### DETAILED DESCRIPTION OF THE DRAWINGS

Description of Monitoring:

With this monitoring method, as illustrated in the flow chart, at least two percentage deviations of the actual yaw rate sensor signal and their models are calculated. Preferably two or more models are taken into consideration herein, first, relating to the steering angle and, second, relating to the wheel signal or, third, to the lateral acceleration. The estimated scaling error in a stationary right-hand curve GF_{right} and/or the estimated scaling error in a stationary left-hand curve GF_{left} are determined.

The scaling errors are newly calculated with every stationary curve detected and used for the detection. The flow chart depicts the situation detection and the estimation of the scaling errors.

Situation Detection:

Starting from a given driving situation 8 to be determined, it is initially found out in rhombus 14 whether a steering movement prevails. A steering movement (detection of a curve) is detected in each case by a comparison of a variable representative of the steering angle and the lateral acceleration with a corresponding threshold value L1, Q1 according to the relations:

|steering angle|>L1, preferably 1° at the wheel

|lateral acceleration|>Q1, preferably 0.081 g

The detection time covers a predetermined time span; e.g. 1 loop. A variable 12 representative of the rotational behavior of the wheels 10 and the steering angle is included in the situation detection in every driving situation. When the conditions of the curve detection are not satisfied, the program run for detecting scaling errors is terminated in 98.

When a curve is identified in 16, it is found out in rhombus 20 whether stationary driving behavior prevails. Detection of stationary driving behavior prevails (stationary detection) when the conditions

\dot{ψ}ₘ_{_{L}}−\dot{ψ}ₘ_{_{Λ}}<K1, preferably 7°/s

\dot{ψ}ₘ_{_{L}}−\dot{ψ}ₘ_{_{ν}}<K2, preferably 7°/s

δLP<K3, preferably 100°/s

α_{q}<K4, preferably 0.5 g

no ABS, no EBD, no BTCS

no non-stationary wheel behavior (slip criteria)

no oversteering driving behavior

no understeering driving behavior

are satisfied. K refers to threshold values. When no stationary driving behavior is found out in 26, the counter will be decremented by 1 in 28 corresponding to the program run, and the run is terminated in 98. The detection time for a stationary driving behavior equals a predetermined time span in 22, preferably ≧7 loops, e.g. 8 loops (1 loop=7 ms). When the detection time is shorter than the predetermined time span, the counter is incremented by 1 in 24 according to said run, and the program run is terminated in 98.

A flag (bit) is set in 30 when the stationary driving behavior was detected in 22 over the predetermined time span of e.g. ≧7 loops. 32 shows the operation of averaging redundancies according to the relation

$${\dot{ψ}}_{mean} = \frac{( {\dot{ψ}}_{{m}_{v}} + {\dot{ψ}}_{{m}_{L}} )}{2}$$

from at least two, preferably four, redundant models available for monitoring the yaw rate sensor, as long as they are valid. The mathematic realization of the process models and their validity is summarized in table 1. The definition of the symbols used in the table is attached as appendix in the description.

TABLE 1

| Table 1 | equations | validity conditions |
|---|---|---|
| model G1 | ${\dot{ψ}}_{{m}_{v}} = \frac{{v}_{vr} - {v}_{vl}}{S}$ | The two front wheels are slip- free, their error flags are not set and the reproduction is in the valid range. |
| model G2 | ${\dot{ψ}}_{{m}_{h}} = \frac{{v}_{hr} - {v}_{hl}}{S}$ | The two rear wheels are slip- free, their error flags are not set and the reproduction is in the valid range. |
| model G3 | ${\dot{ψ}}_{{m}_{q}} = \frac{{a}_{q}}{{v}_{ref}}$ | Driving speed must be higher than zero. |
| model G4 | ${\dot{ψ}}_{{m}_{L}} = \frac{{δ}_{L}}{{i}_{L} l} \frac{{v}_{ref}}{( 1 + {( \frac{{v}_{ref}}{{v}_{ch}} )}^{2} )}$ | no countersteering, no significant steering at high vehicle speed. |

34 calculates a percentage difference value Δ\dot{ψ}(%)=(\dot{ψ}_{Sensor}/\dot{ψ}ₘₑₐₙ) from the deviation of the value of the yaw rate signal from the redundant mean value.

Only the case of error for a right-hand curve is illustrated in the flow chart. The monitoring operation for a left-hand curve is identical. The description (starting with rhombus 50 of the flow chart) therefore relates exemplarily to a right-hand curve. When the percentage difference value Δ\dot{ψ}>60%, a positive scaling error suspicion (GAINFAILURES) is assumed, this is revealed by a flag (bit) (SMAL_POS_GAINFAILUR_SUSPICION=1) in 52.

1. It is checked in 54 whether the percentage difference value Δ\dot{ψ}>80%. Subsequently, a polling is performed in 56 whether there was a negative scaling error suspicion (NEG_GAIN_FAILURE_SUSPICION=1) in the preceding run (loop) and there is a positive scaling error suspicion in the instantaneous program run. When a positive scaling error suspicion prevails, the negative scaling error suspicion (NEG_GAIN_FAILURE_SUSPICION=0) is reset in 58, and the counter (GAIN_FL_SUSP_CNT_R) that is common for the positive and negative scaling error suspicion is reset in 58 because it is assumed that it is impossible for a positive and negative error to occur simultaneously. This procedure reduces the necessary RAM memory, and it helps economizing RAM resources. In 60 the positive scaling error suspicion is confirmed, and the error counter (GAIN_FL_SUSP_CNT_R++) is incremented by 1.

The loop 52-60 characterized by 1) is identical to the loop 52.1-60.1 when a negative scaling error suspicion prevails (percentage difference proportion <−50%).

The program run in the flow chart following now is identical for positive and negative errors.

When one of the two scalina error counters 60, 60.1 in 70 has an error suspicion (with a scaling error >80%) for e.g. 175 msec or. 25 loops, or preferably 70 msec or 10 loops, and the scaling error is greater than 60%, then the ESP (AYC) control entry threshold as well as the ESP control exit threshold will be raised. The scaling error can be reduced from >80% to >60% due to the duration provided in 70. In 72, a factor of the percentage difference value Δ\dot{ψ} (%) of the filtered yaw rate reproduction resulting from the steering angle

$$( {\dot{ψ}}_{{m}_{L}} = \frac{{δ}_{L}}{{i}_{L} l} \frac{{v}_{ref}}{( 1 + {( \frac{{v}_{ref}}{{v}_{ch}} )}^{2} )} )$$

weighted (reduced) with a predetermined correction value with regard to the ESP entry threshold (−2° per sec), is added to the entry and exit thresholds, that means, the thresholds are raised by the calculated percentage.

Should the error counter have counted to a value, e.g. to 15 or 30, in 74, then this fact is considered an error in 76 (GAIN_FAILURE_DETECTED_R=1).

The above-mentioned description is executed separately for right-hand and left-hand curves.

When now this monitoring element 78 has two times detected this error in the same direction, e.g. (GAIN_FAILURE_DETECTED_R==2) or has detected one error for the right and one for the left, this is assumed as final error detection 80, and the system is deactivated with error entry (SET_FAILURE=GAIN_FAILURE).

These error counters are reset when oversteering is detected or when no further scaling threshold exceeding event is detected in the further stationary course of curve for a duration ranging between e.g. 15 sec and 5 min.

The symbols used hereinabove are defined as follows:

| | |
|---|---|
| vᵥᵣ | speed at right front wheel; |
| vₕᵣ | speed at right rear wheel; |
| vₕₗ | speed at left rear wheel; |
| vᵥₗ | speed at left front wheel; |
| v_{ref} | vehicle reference speed; |
| ${\dot{ψ}}_{{m}_{v}}$ | model yaw rate from the front wheel speeds; |
| ${\dot{ψ}}_{{m}_{h}}$ | model yaw rate from the rear wheel speeds; |
| ${\dot{ψ}}_{{m}_{q}}$ | model yaw rate from the lateral acceleration; |
| ${\dot{ψ}}_{{m}_{L}}$ | model yaw rate from the steering angle; |
| a_{q} | lateral acceleration; |
| δ_{L} | steering wheel angle; |
| i_{L} | steering ratio; |
| l | wheel base; |
| S | track width of the vehicle; |
| v_{ch} | characteristic driving speed; |
| δ_{LP} | steering angle velocity. |

${\dot{ψ}}_{{m}_{L}} = \frac{{δ}_{L}}{{i}_{L} l} \frac{{v}_{ref}}{( 1 + {( \frac{{v}_{ref}}{{v}_{ch}} )}^{2} )}$
${\dot{ψ}}_{mean} = \frac{( {\dot{ψ}}_{{m}_{v}} + {\dot{ψ}}_{{m}_{L}} )}{2}$
${\dot{ψ}}_{{m}_{q}} = \frac{{a}_{q}}{{v}_{ref}}$
${\dot{ψ}}_{{m}_{v}} = \frac{{v}_{vr} - {v}_{vl}}{S}$
${\dot{ψ}}_{{m}_{h}} = \frac{{v}_{hr} - {v}_{hl}}{S}$

1. Method of controlling the driving stability of a vehicle, wherein signal errors emitted by yaw sensors are determined by way of monitoring strategies, characterized in that during stationary driving behavior with a steering movement it is determined whether the value of the yaw rate signal (\dot{ψ}_{Sensor}) deviates in percentage or nominally from a redundant value (\dot{ψ}ₘₑₐₙ ) produced from other measured or calculated variables of the vehicle, and that in this case the control (72, 80) of driving stability is influenced under the condition that a comparison value (Δ\dot{ψ}(%)) produced from the value of the yaw rate sianal (\dot{ψ}_{Sensor}) and the redundant value (\dot{ψ}ₘₑₐₙ) exceeds at least one predetermined threshold value (>80%, >60%).

2. Method as claimed in claim 1, characterized in that the value of the yaw rate signal is compared with the redundant value when a counter (22) reaches a predetermined value.

3. Method as claimed in claim 1 or 2, characterized in that the counter (22) is increased in dependence on a time lapsed (≧7) during which the stationary driving behavior with a steering movement is determined.

4. Method as claimed in any one of claims 1 to 3, characterized in that stationary driving behavior (20) is determined when at least one of the following conditions is satisfied:
a) |\dot{ψ}ₘ_{_{L}}−\dot{ψ}_{mq}|<a first threshold value K1, preferably 12°/s, especially 7°/s
a) |\dot{ψ}ₘ_{_{L}}−\dot{ψ}ₘ_{_{ν}}|<a second threshold value K2, preferably 12°/s, especially 7°/s
b) |δLP|<a third threshold value K3, preferably 200°/s, especially 100°/s
c) |α_{q}|<a fourth threshold value K4, preferably 0.7 g, especially 0.5 g
d) anti-lock control (ABS), electronic brake force distribution (EBD), brake intervention-traction slip control is not active, and/or
e) the wheels of the vehicle do not show non-stationary wheel behavior (slip criteria)
f) the vehicle does not show oversteering driving behavior
g) the vehicle does not show understeering driving behavior.

5. Method as claimed in any one of claims 1 to 4, characterized in that a steering movement is determined when at least the conditions are satisfied:

|steering angle|at the wheel>threshold value L1, preferably 1°, and

|lateral acceleration|>threshold value Q1, preferably 0.081 g.

6. Method as claimed in any one of claims 1 to 5, characterized in that the redundant value is produced from at least two model-based variables in which at least one of the following variables is included: wheel speeds of the wheels, track width, steering wheel angle, wheel base, vehicle speed, vehicle reference speed, the characteristic vehicle speed, or the steering velocity.

7. Method as claimed in claim 6, characterized in that the redundant value is produced by averaging (32) according to the relation
$${\dot{ψ}}_{mean} = \frac{( {\dot{ψ}}_{{m}_{v}} + {\dot{ψ}}_{{m}_{L}} )}{2}$$
preferably with \dot{ψ}ₘ_{_{ν}}according to the relation
$${\dot{ψ}}_{{m}_{v}} = \frac{{v}_{vr} - {v}_{vl}}{S}$$
and with \dot{ψ}ₘ_{L} according to the relation
$${\dot{ψ}}_{{m}_{L}} = \frac{{δ}_{L}}{{i}_{L} l} \frac{{v}_{ref}}{( 1 + {( \frac{{v}_{ref}}{{v}_{ch}} )}^{2} )} .$$

8. Method as claimed in any one of claims 1 to 7, characterized in that the comparison value is determined (34) as a percentage difference value Δ\dot{ψ}(%)=(\dot{ψ}_{Sensor}/\dot{ψ}ₘₑₐₙ) from the deviation of the value of the yaw rate signal \dot{ψ}_{Sensor} from the redundant value \dot{ψ}ₘₑₐₙ.

9. Method as claimed in any one of claims 1 to 8, characterized in that a flag (bit) (SMAL_POS_GAIN_FAILURE_SUSPICION) is set (52) when the percentage difference value exceeds a threshold value K5 (DELTA_YA>60%).

10. Method as claimed in any one of claims 1 to 9, characterized in that a flag (bit) (POS_GAIN_FAILURE_SUSPICION or NEG_GAIN_FAILURE_SUSPICION) is set when the percentage difference value exceeds a threshold value K6 (DELTA_YR>80%) or threshold value K7 (DELTA_YR<−50%).

11. Method as claimed in any one of claims 1 to 10, characterized in that the value of a counter (60) for a positive scaling error suspicion or the value of a counter (60.1) for a negative scaling error suspicion is increased when a positive or negative scaling error (>80%) is determined.

12. Method as claimed in any one of claims 1 to 11, characterized in that an ESP entry and/or exit threshold is increased by a model-based redundant value \dot{ψ}ₘ_{_{L}} that is weighted with a factor of the percentage difference value Δ\dot{ψ}(%) when the value of the counter (60, 60.1) exceeds a threshold value K8 (70).

13. Method as claimed in claim 12, characterized in that the model-based redundant value is calculated according to the following relation
$${\dot{ψ}}_{{m}_{L}} = \frac{{δ}_{L}}{{i}_{L} l} \frac{{v}_{ref}}{( 1 + {( \frac{{v}_{ref}}{{v}_{ch}} )}^{2} )}$$
and the ESP entry threshold is weighted with a correction value (−2°/s).

14. Method as claimed in any one of claims 1 to 13, characterized in that the control of driving stability is terminated when the counter (78) has reached or exceeded a ninth threshold value K9 and the number of exceeding events satisfies a predefined provision.

15. Method as claimed in any one of claims 1 to 14, characterized in that an error is registered in an error memory when driving stability control is terminated.

16. Method as claimed in any one of claims 1 to 15, characterized in that the counters are reset when an ESP oversteering condition is found out.

17. Method as claimed in any one of claims 1 to 16, characterized in that the counters are reset when no scaling threshold exceeding events (50, 54.1) in a stationary curve are detected in a predetermined period.
